(19) United States
(12) Patent Application Publication
(10) Pub. No.: US 2002/0059583 A1
(43) Pub. Date: May 16, 2002

(54) Method of managing contents data for digital broadcasting by using an application definition file and a management system thereof

(75) Inventor: Moon-Young Kim, Kyungki-do (KR)

Correspondence Address: MERCHANT & GOULD PC, P.O. BOX 2903, MINNEAPOLIS, MN, 55402-0903, US

(73) Assignee: Alticast Corp.

(21) Appl. No.: 09/917,119

(22) Filed: Jul. 27, 2001

(30) Foreign Application Priority Data
Jul. 29, 2000 (KR) 10-2000-44084

(51) Int. Cl. H04N 7/025

(52) U.S. Cl. 725/32

(57) ABSTRACT

The present invention relates to a method of managing contents data for digital broadcasting. The method of the present invention includes the steps of a) collecting contents data for digital broadcasting in form of an application, b) designing an application definition file according to characteristics of respective contents contained in the application, c) inputting the designed application definition file and the application into a server, and d) Processing the application in accordance with the input application definition file. The application processed in the server by a method defined through a transmission standard for a digital broadcasting and the encoded application is generated to a transport stream then transported to the viewer.

### BACKGROUND OF THE INVENTION

1. Field of the Invention

The present invention relates to a method of managing contents data for digital broadcasting, more especially to a method of managing the contents which provides various information of the programs such as the drama or movies which are transmitted from the broadcasting station together with video and voice data of the programs in a digital broadcasting.

2. Description of the Related Art

In conventional television broadcasting system, the electric wave is transmitted by analog modulation of the audio and/or video signals, a viewer can watch the broadcasting program by which a receiver demodulates the signals. While, according to a digital broadcasting system, which transmits the audio and/or video signals that are modulated in digital, since the video and audio as well as various data of the program can be transmitted to a viewer, the viewer can get the various information for the program while watching the program. Here, the information provided with the program is defined as contents in the present invention and the contents can be variously formed according to the program.

However, since the broadcasting station, which should provide the contents, must prepare to transmit the various contents by adding the information into the audio and the video data, it is required a lot of time and workmen for maintenance and management of the contents. Moreover, it should be accompanied the difficulty for searching contents to be necessary to a specification program among great many contents.

Also, the disclosure in the Korean Patent Application No. 10-2000-31441, entitled ‘Producing system for a digital television contents and a method thereof’, which is filed by the same applicant (assignee) of the present invention prior to the present invention has a technological relationship to the present invention.

### SUMMARY OF THE INVENTION

Therefore, the present invention is made to overcome the problems of the prior art, it is an object of the present invention to provide a method of efficiently and systemically managing the contents to be provided together with a program.

To achieve the object of the present invention, the method according to the present invention comprises the steps of: a) collecting contents data for digital broadcasting in form of an application; b) designing an application definition file according to characteristics of respective contents contained in the application; c) inputting the designed application definition file and the application into a server; and d) processing the application in accordance with the input application definition file.

### BRIEF DESCRIPTION OF THE DRAWINGS

These and other objects and advantages of the present invention will become apparent and more readily appreciated from the following description of the preferred embodiments, taken in conjunction with the accompanying drawings of which:

FIG. 1 is a flowchart illustrating a method of transmitting contents data according to the present invention;

FIG. 2 is a view showing an example for illustrating an application definition file according to the present invention;

FIG. 3 is a view showing an example of the application definition file according to the present invention;

FIG. 4 is a schematic diagram of an example of a digital data transmission system to which the method of the present invention is applied; and

FIG. 5 is a lock diagram of an application server according to the present invention.

### DETAILED DESCRIPTION OF THE PREFERRED EMBODIMENTS

Hereinafter, the preferred embodiments of the present invention will be described in detail with reference to the accompanying drawings.

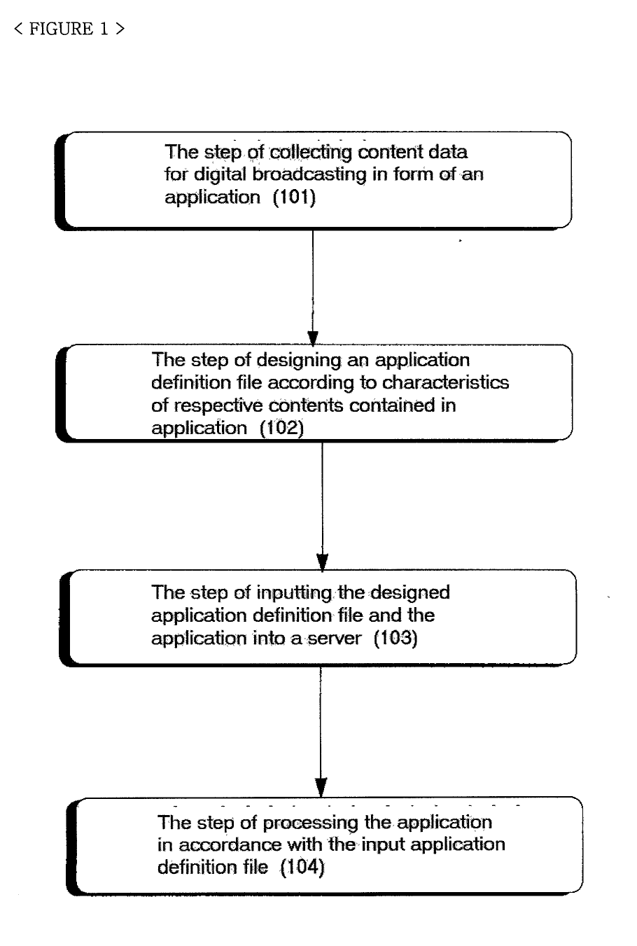

FIG. 1 is a flowchart for illustrating a method of transmitting contents data according to the present invention. The description of FIG. 1 follows.

1. The step of collecting 101 contents data for digital broadcasting in form of an application

A provider of the broadcasting program should run processing for storage and maintenance and management of a lot of the contents that can be produced exponentially according to the broadcasting program for smooth progress of digital broadcasting, hardware and software for transmission of data must be performed mutually organically. At this time, a lot of time and man power are required to recognize composition of all the contents and define necessary encoding method or quantity of the contents to be used every time. Also, information for each the contents should be maintained for exchanging each other consistently within a transmission system. According to the present invention, to solve these problems, the present invention collects the related contents to each other data in the form of application.

The application has a characteristic like as an aggregate of the contents to be used in a broadcasting program. For example, when the contents are made, the contents are designed in a way that the contents for the advertisement in a drama is joined to an advertisement application, the contents for the characters in the drama is joined to a character introductive application. The contents data is provided to the viewer by transmitting the applications together with the video and audio data when the digital broadcasting is transmitted. Also, many applications can be made out in one broadcasting program and a plurality of applications can be made in one broadcasting program while each application may include a plurality of contents belong to the corresponding application. The applications are produced in a way of binding contents data that are made by various kinds conventional authorizing tools producing the contents for the broadcasting program into one data file form. More especially, in the embodiment of the present invention, the application is produced according to the disclosure in the Korean Patent Application No. 10-2000-31441, entitled ‘Producing system for a digital television contents and a method thereof’, which is filed by the same applicant (assignee) of the present invention prior to the present invention.

2. The step 102 of designing an application definition file according to characteristics of respective contents contained in the application.

In this step, name and characteristics of the respective contents to be contained in the broadcasting program are defined. According to the method of the present invention, the design for the management and administration of the contents for broadcasting is more convenient through the Application definition file (Application Definition File, hereinafter referring to an ADF) that have information about name of the contents and various characteristics. Since the ADF is a kind of a program, a programmer may make out the ADF by selecting a desirable programming language. However, in order to design program so that can efficiently manage the application for digital broadcasting, the ADF according to the present invention defines following characteristics.

1) Portion of defining a transmission standard of the application

The transmission standard indicates a data format standard for a digital broadcasting such as a coding standard according to an ATSC (Advanced Television Standard Committee) of North America area, a DVB (Digital Video Broadcasting) of Europe area, and an ISDB (Integrated Services Digital Broadcasting) of Japan. The transmission standard is a portion defining whether the application is applied by one of the standards. Designing the ADF according to the present invention, the transmission standard may be decided in accordance with the standards that a system transmitting data uses.

2) Portion of defining name of the application

Since the application may be at least one in the broadcasting program as descried above, it needs to define the name of the application. Therefore, in order to distinguish the respective applications, the name of the application is defined.

3) Portion of defining an executing environment of the application

The application is executed by a peripheral hardware and software in use when the application is executed in the transmission system for digital broadcasting. Therefore, the execute environment of the application should have a mutual compatibility with the hardware and software in use, the environment of the hardware and software where the application is executed is defined.

4) Portion of defining the encoding way of the application

The application that contain various contents data as described above is encoded by a predetermined data stream according to the transmission standard that the digital broadcasting uses when the application is transmitted to viewer. This portion is a portion for defining the encoding way according to the characteristic of data such as Piping of data, Data Carousel that is kind of Schedule that periodic repeat transmission of the application is possible, an Asynchronous IP (Internet Protocol) used when data related to Internet is mainly transmitted and Synchronous Stream used in transmission of data containing synchronized information, Synchronized Stream. More especially, in case of the synchronous stream, time information that can be synchronized is contained. Moreover, a method of grouping data module that is aggregate of these unit data stream is defined in this portion.

5) Portion of defining a method to transmit the application

In digital broadcasting, between the transport stream and the viewer's digital television that receives the transmitted transport stream, there are a protocol as a rule for the transmission of data and exchange thereof. The protocol is applied to the application when the application is transmitted consecutively. In this portion, a method to transmit the application's data to viewer repeatedly using the protocol is defined.

6) Portion of defining itself information of application

This is a portion that defines input information that can be contained when the application is executed by the digital broadcasting transmission system, and defines several items executed when the application is received and executed in the viewer's television set such as screen size of the application and whether the application is automatically executed.

3. Step 103 of inputting the designed application definition file and the application into a server

The server is a system that stores the application and the ADF and manages the application according to loaded information by loading information about the application and processing commands. For this, the server has a predetermined storing space and many modules that processes the application. The ADF may be inputted to the server automatically by using the transmission protocol (TCP/IP SOCKET, FTP, BIOP etc.) from outside, or directly by a user with a recording medium such as a diskette or a compact disk. The input method can be divided into as following in accordance with engagement of the application that the ADF defines.

1) Method of inputting both of the application and the ADF that is made with the application to the server

2) Method of storing contents necessary to the server and inputting the ADF by designing the ADF according to the stored contents

3) Method of inputting the ADF by correcting the ADF when the added contents is made in case of adding new contents to the application stored in the server

4) Step 104 of processing the application in accordance with the input application definition file

Application that is inputted to server is reconstructed by a main controller described after by reading the ADF that is necessary to data broadcasting in accordance with a schedule of the broadcasting program. That is, while managing the broadcasting schedule of whole programs, the main controller loads the ADF from the server at starting time when the application in the server is transmitted together with the broadcasting. Based on the loaded ADF, the main controller gives to an encoding section described after a command to encode the application, and to a system information generating section described after information that commands to generate system information necessary to which the application is broadcasted. At this time, both of the information transmitted to the data encoding section and the system information generating section is made based on the information of the ADF, contents of the information are information about the applications to be encoded and the encoding method for transmitting the applications and the information which a receive section of the digital data (for example, a television set for receiving the digital data) requires to receive the transmitted applications. A system manager who transmits the data for the digital broadcasting produces and inputs the ADF into the server, makes the server manage the applications containing the contents by interpreting the ADF, then whole transmission system can be operated organically.

According to the present invention, the various contents for the digital broadcasting can be efficiently managed, after this the processed application in accordance with the ADF in the server undergoes data encoding that the application is encoded by the defined way of the transmission standard for the digital broadcasting as described above as follow. That is, in the process, by coding the application defined in accordance with the transmission standard by encoding, a data stream having a predetermined format is generated, and the encoded application is made to a transport stream as a final form to be transmitted to the viewer. The transport stream is converted to the electric wave while passing through a digital modulating circuit and a radio transmission circuit, and finally transmitted through an antenna. The viewer can enjoy the variety of the contents received together with the program by which the data stream is displayed on a screen of the television set of the viewer.

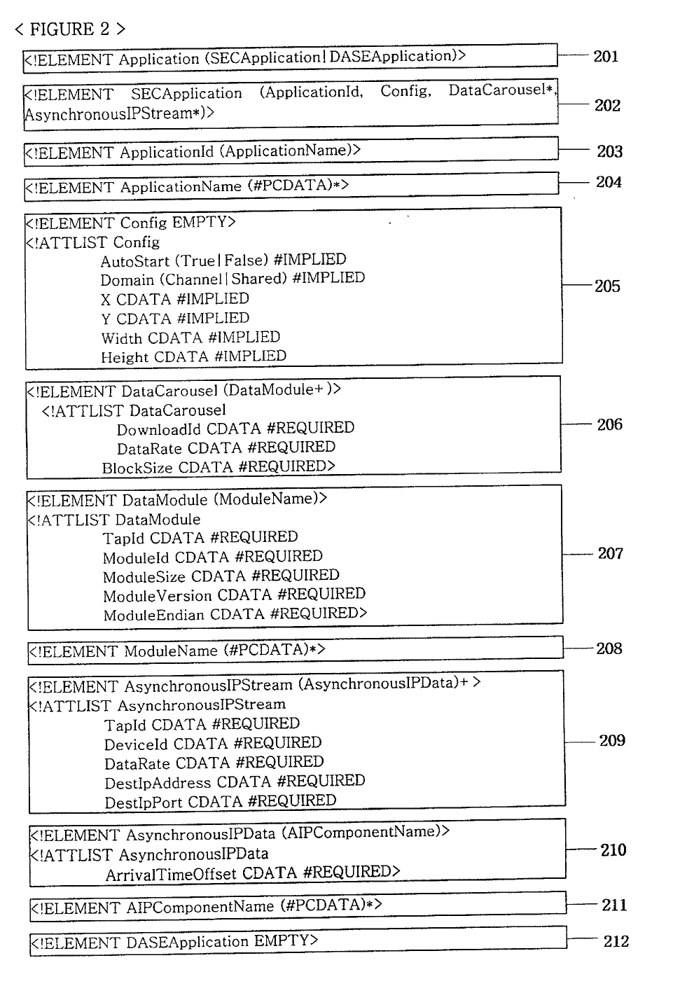

FIG. 2 is a view showing an example for illustrating an application definition file according to the present invention. In this embodiment, the ADF is described by using XML language. The XML (eXtensible Markup Language), which is a language that displays a document file or a multimedia file on a browser in Internet and for efficiently performing the exchange of the files, is a language which can structurally design that can define more systemic and consistent access way than HTML (Hyper Text Markup Language) that is utilized widely in World Wide Web. Moreover, since a TAG used as a mark for describing contents to be performed on the browser is fixed in the HTML, while the XTML allows to a designer to voluntary make the TAG, the extensity of the XTML is superior. The XML language has a kind of frame of a DTD (Document Type Definition), the file expressed by the XML is produced according to the structure of the DTD after the DTD that structurally expresses the contents to be contained in the file. The DTD acts role as a frame that preset elements such as name, form, and expression way of the respective XML files, and FIG. 2 is an example that illustrates DTD for designing an ADF according to the present invention. The structure is described below by referring to the figures. The ADF file consists of greatly 3 parts of a part 201, which defines a type of an application, a part 202, which defines components of the corresponding application, and a part 203 to 212, which defines contents of the components. In the part 201, what category each application is included is defined. Here, DASE application that defines DASE application of ATSC of United States of America standard and SEC application to be defined by being included in specific company's category appear as simple examples. This part is defined additionally by new standard in the future. In the part 202, the components necessary to set each component of the application are defined. Parts of the part 203 to 212 in accordance with the values which are defined in the part 202 is defined, and necessary values thereof are defined. In the part 203, an application ID to be defined in order to classify an application is defined. In the part 204, the name of the application, which is an element of the application ID, is defined. Structural information related to the application is defined. In this part, defined whether the application is automatically started or not, and a position on a screen which the application is executed and size thereof. The parts 206, 209, 210 are parts that encoding method corresponding to the respective data module is defined. 206 is a part for illustrating a data transmitting method according to the DataCarousel by using a download protocol of DSM-CC. The DSM-CC (Digital Storage Media Command and Control) is a kind of protocol for a digital broadcasting, and the DataCarousel is a scenario that pre-sets a method for continuously transmitting data of the application to the viewer. That is, a transmitting order of the several applications contained in a broadcasting program is determined in advance. When the viewer downloads the data in accordance with the method of the part 206, a download ID, a data rate, and a data size are designated. Moreover, the respective data, modules that are an aggregate of a unit data stream to be inserted into the DataCarousel, can include at least one unit data stream according to the definition of the data module in the part 207. In addition, the name, a divider which divides the data module, has a structure of a NameModule, and the aspect is identical as shown in the part 208. In the par 209, it is illustrated an encoding method of designating an Asynchronous IP data stream. As shown in FIG. 2, encoding method of tap id, device id, data rate, destination IP address, and destination IP port is designated. In the part 210, data module of the id stream to be arrived in corresponding time is illustrated, and the arrived time of the corresponding data is designated as an offset time. Moreover, it is illustrated that the data name is consisted of the structure of the AIPComponentName which is illustrated in the part 211. In the part 212, the definitions in the parts 203 to 211 are utilized for new application, or new item can be added by defining the new item.

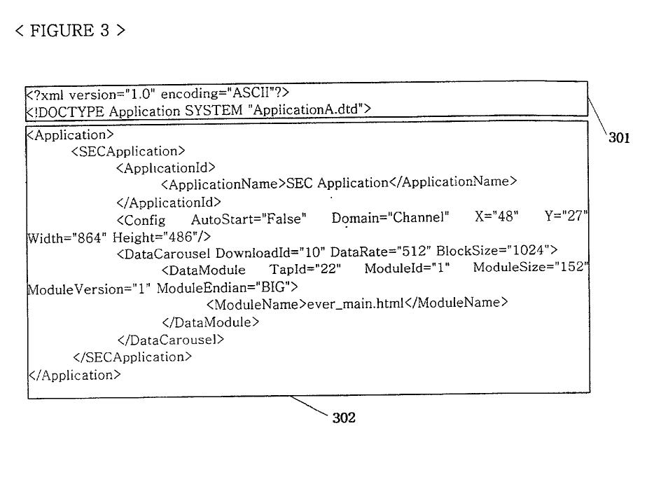

FIG. 3 is a view showing an example of the ADF which is made by using DTD of FG. 2, and declaration statement of the part 301 indicates the fact that the DTD defined in FIG. 2 is utilized. In the part 302, the structure according to grammar of FIG. 2 is illustrated.

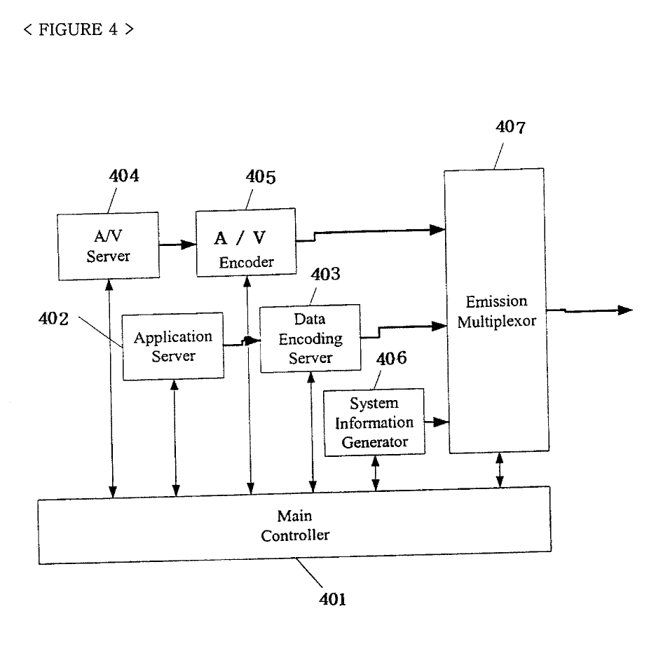

FIG. 4 is a schematic diagram of an example of a digital data transmission system to which the method of the present invention is applied. Since in the digital broadcasting, not only the contents but also the video and audio data which the viewer watches are digitalized and transmitted together with the contents data, systems are added necessary to process the video and audio data, and described with reference to FIG. 4.

The system according to the present invention includes a main control section 401, an application server section 402, a data encoding section 403, a audio and video server section 404, a audio and video data encoding section 405, a system information generating section 406, and a transmitting multiplexer section 407, and function and operation of the respective sections are described in detail.

The main control section 401 performs a role of controlling operating status and flow of respective processing sections by transmitting and receiving a control signal to and from the processing section and commands operation of the respective processing sections.

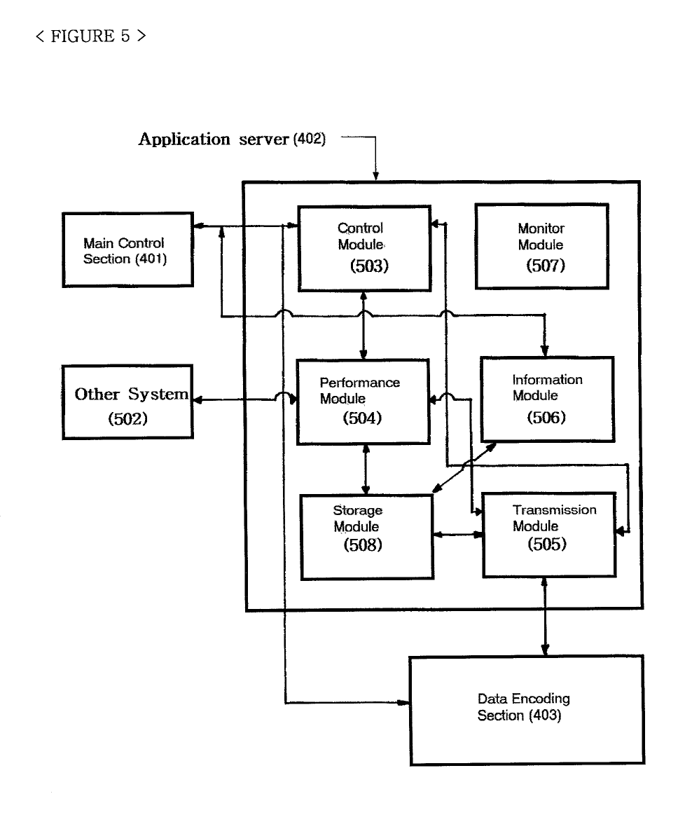

The application server section 402, which is the extremely essential part of the system according to the present invention, performs the processing for storage, maintenance, and management of a plurality of contents that may be produced in geometric progression in accordance with the broadcasting program. The application server performs works by receiving all commands from the main control section 401. The application server is roughly divided into six functional modules such as a control module 503, a performance module 504, a transmission module 505, an information module 506, a monitor module 507, and a storage module 508 as shown in FIG. 5. The roles of the modules follow.

1) Control module 503

The control module 503 processes the command from the main control section 401, and controls the performance module 504 and the transmission module 505. There are principal commands of performing the application, loading the contents data, loading the ADF, and searching the applications.

2) Performance module 504

The performance module 504 loads files to construct the application and the corresponding ADF from exterior other system by control of the control module 503 and transmits the files and ADF to the storage module 508 to store the files and ADF.

3) Transmission module 505

The transmission module 505 transfers information of the application to the data encoding section 403. Especially, in the case of on-line data service, the performance module 504 reads the data by connecting to a server having the corresponding data and transmits the data to the transmission module 505, then the transmission module 505 transmits the data to the data encoding section 403.

4) Information module 506

The information module 506 performs search and correction of the information of the application in the storage module 508.

5) Monitor module 507

Occurred problems during monitoring interior status of the server, the monitor module 507 directly displays an alarm signal and information of the problems to an operator. Moreover, the monitor module 507 records principal operation such as performance of the application and loading of the contents data every hour, so that the records can be observed at need in the future.

6) Storage module 508

The storage module 508 is a kind of database undertaking the storage of the information of the application.

The principal functions of the application server including the module as described above follow.

1) Function to bring all files constructing the application in the exterior other server 502 together with the ADF of the application by receiving commands that are performed by unit of application from the exterior other system 502.

2) Function to store and manage the files in unit of application together with the ADF.

3) Function to transfer the ADF to the exterior by request of other system.

4) Function to search and correct the information for the application that is stored by an exterior controller or own interface.

5) Function to provide the monitoring information of the server to the operator.

6) Function to process several protocols supporting types of contents data.

Moreover, the application server divides the contents data in to an offline data and an online data in accordance with property of the content data. The offline data is the data of which the contents are already made is utilized without connecting to exterior other server of which the information of the contents, while the online data is data of which the contents are changed by connecting to the exterior other server at ay time. When the offline data is utilized, the performance module 504 collects the relative information by connecting the exterior other server 502 by the performance command from the control module 503 and stores the information in the storage module 508. After this, the information is transferred at the request of the data encoding section 403. While when the online data is utilized, the performance module 504 received the request from the data encoding section 403 to collect information by connecting the exterior other server 502 and to directly transfer the collected information to the data encoding section 403 through the transmission module 505 without storing data by the storage module 508.

The application server is a unique server to connect to exterior other servers so that exposure of whole the broadcasting system is minimized. This minimized exposure is proper type to the broadcasting station which requires strict security and protects any malicious access from exterior as possible as.

Moreover, the application server provides a protocol, a method for data communication the exterior other server which provides applications. For this, the performance module of the application server provides a general and flexible interpretation method for compatibility with various communication protocols with the exterior servers.

By the flexible data interpretation method, programs of the application server supporting the various communication protocols convert the contents data receiving from the exterior servers data to be utilized in the application server.

The data encoding section 403 generates the data stream of the contents by coding through the method defined to the transmission standard after receiving the required contents by request the application server. Here, there are several transmission standards, that is, a coding method of the ATSC (Advanced Television Standard Committee) of North America which is being established at the present time, a coding method of the DVB (Digital Video Broadcasting) of Europe, and a coding method of the ISDB (Integrated Services Digital Broadcasting) of Japan, the coding format is designed according to the desired coding method in the present invention.

The audio and video server 404 which stores and manages the digital data for the audio and video signal of broadcasting program, transfers the corresponding audio and video data to the encoding section when the data request signal is received from the encoding section.

The audio and video encoding section 405 sends data request signal to the audio and video server and receives the requested data. The received data is coded in accordance with the transmission standard to generate the audio and video data stream. At this time, the transmission standard can be coded according to the various standards as described above.

The system information generating section 406 generates a data stream a system information to be required for an emission multiplexer to generate a transport stream and transfers the information to the multiplexer.

The emission multiplexer 407 receives respective data streams from an audio and video data encoding section, a contents data encoding section, and the system information generating section, and generates the respective data streams to final data streams according to the transmission standard to be transmitted to the viewer. At this time, let the final data stream as the transport stream of the present invention. The transport stream is converted to the electric wave while passing through a digital modulating circuit and a radio transmission circuit, and finally transmitted through an antenna. The viewer can enjoy the variety of the contents received together with the program by which the data stream is displayed on a screen of the television set of the viewer.

According to the present invention as describe above, since works for operation and management of the contents for the digital broadcasting are performed by the server by separating the works from the operator, error that would be occurred in the actual broadcasting is executed or the transport of the data can be minimized, and moreover, the operator is allowed to process not much data, so that the efficiency of the business can b maximized.

Although the method of managing contents data for digital broadcasting by using an ADF of the present invention has been shown and described with reference to accompanying drawings, it will be appreciated by those skilled in the art that changes may be made in these embodiments without departing from the principles and spirit of the invention, the scope of which is defined in the claims and their equivalents.

What is claimed is:

1. A method of managing contents data for digital broadcasting by using an application definition file, comprising the steps of:
a) collecting contents data for digital broadcasting in form of an application;
b) designing an application definition file according to characteristics of respective contents contained in the application;
c) inputting the designed application definition file and the application into a server; and
d) processing the application in accordance with the input application definition file.

2. The method as claimed in claim 1, wherein the step a) comprises the sub-steps of:
1) defining a transmission standard of the application;
2) defining a name of the application;
3) defining an executing environment of the application;
4) defining an encoding way of the application;
5) defining a method to transmit the application; and
6) defining itself information of the application.

3. The method as claimed in claim 1, wherein in the step c), both of the application and the ADF that is made with the application are inputted to the server.

4. The method as claimed in claim 1, wherein in the step c), contents necessary are stored to the server and the ADF is inputted to the server by designing the ADF according to the stored contents.

5. The method as claimed in claim 1, wherein in the step c), the ADF is inputted by correcting the ADF when the added contents is made in case of adding new contents to the application stored in the server.

6. The method as claimed in claim 3 to 5, wherein in the step c), the ADF is inputted to the server automatically by using the transmission protocol from outside, or directly by a user with a recording medium such as a diskette or a compact disk.

7. The method as claimed in claim 1, wherein the step d) comprises the sub-steps of:
1) loading the ADF from the server at starting time when the application in the server is transported together with at the beginning of the broadcasting while a main controller section manages the broadcasting schedule of whole programs;
2) giving an information of a command for encoding the application based on the loaded ADF; and
3) commanding to generate a system information necessary to which the application is broadcasted.

8. A system for managing contents data for digital broadcasting by using an application definition file, comprising:
a main control section for controlling an operating status and flow of an application server section by transmitting and receiving a control signal to and from the application server section; and
the application server section for storing a data broadcasting program necessary to the digital broadcasting and systemically maintaining and managing the data broadcasting program.

9. The system as claimed in claim 8, wherein the application server section comprises a control module, a performance module, a transmission module, a storage module, a monitor module, and an information module.

10. The system as claimed in claim 8, wherein the application server section brings all files constructing the application in an exterior other server together with the application definition file of the application by receiving commands that are performed by unit of application from the exterior other system.

11. The system as claimed in claim 8, wherein the application server section stores and manages files in unit of application together with the application definition file.

12. The system as claimed in claim 8, wherein the application server section transfers the application definition file to an exterior by request of the exterior, and searches and corrects the information for the application that is stored by an exterior controller or own interface of the application server section.

13. The system as claimed in claim 8, wherein the application server section provides a monitoring information in an application server to an operator.

14. The system as claimed in claim 8, wherein the application server section processes several protocols supporting types of contents data.

15. The system as claimed in claim 8, wherein the application server section divides a contents data into an offline data and an online data in accordance with property of the content data.

16. The system as claimed in claim 15, wherein a relative information of the offline data is collected by a performance command from the performance module which connects to an exterior other server, stored in the storage module 508, and transferred to the contents data encoding section by the request in advance, and
the online data is collected by the performance module which connects to the exterior other server by receiving the request from the data encoding section, and directly transferred to the data encoding section through the transmission module without storing data by the storage module.

17. The system as claimed in claim 8, wherein the performance module of the application server provides a general and flexible interpretation method for compatibility with various communication protocols with an exterior server, and programs of the application server supporting the various communication protocols convert the contents data receiving from the exterior servers data to be utilized in the application server.
